(19) United States
(12) Patent Application Publication
(10) Pub. No.: US 2023/0256335 A1
(43) Pub. Date: Aug. 17, 2023

(54) DISPLAY METHOD AND APPARATUS FOR REAL-TIME BATTLE INFORMATION, TERMINAL, AND STORAGE MEDIUM

(71) Applicant: Tencent Technology (Shenzhen) Company Limited, Shenzhen (CN)

(72) Inventors: Yiqi LI, Shenzhen (CN); Ya ZHANG, Shenzhen (CN); Han WEN, Shenzhen (CN); Lin LIN, Shenzhen (CN); Haohui LIANG, Shenzhen (CN); Yinchao CHEN, Shenzhen (CN)

(21) Appl. No.: 18/140,604

(22) Filed: Apr. 27, 2023

Related U.S. Application Data
(63) Continuation of application No. PCT/CN2022/109634, filed on Aug. 2, 2022.

(30) Foreign Application Priority Data
Sep. 1, 2021 (CN) 202111022460.0

(51) Int. Cl. A63F 13/537; A63F 13/52

(52) U.S. Cl. CPC A63F 13/537; A63F 13/52

(57) ABSTRACT

A method for displaying real-time battle information is performed by a terminal. The method includes: displaying a user interface of a battle; displaying, within the user interface of the battle, identifiers of user accounts participating in the battle, the identifier of each user account having a display region and the display region comprising a plurality of sub-regions, different sub-regions corresponding to different information categories; and in response to an operation on a target sub-region in a display region of a target identifier, displaying real-time battle information of a target information category of a target user account corresponding to the target identifier, the target information category being an information category corresponding to the target sub-region.

### CROSS-REFERENCE TO RELATED APPLICATIONS

This application is a continuation application of PCT Patent Application No. PCT/CN2022/109634, entitled “DISPLAY METHOD AND APPARATUS FOR USER REAL-TIME BATTLE INFORMATION, TERMINAL, AND STORAGE MEDIUM” filed on Aug. 2, 2022, which claims priority to Chinese Patent Application No. 202111022460.0, entitled “DISPLAY METHOD AND APPARATUS FOR USER REAL-TIME BATTLE INFORMATION, TERMINAL, AND STORAGE MEDIUM” filed on Sep. 1, 2021, all of which is incorporated by reference in its entirety.

### FIELD OF THE TECHNOLOGY

Embodiments of this application relate to the field of computer and Internet technologies, and in particular, to a display method and apparatus for real-time battle information, a terminal, and a storage medium.

### BACKGROUND OF THE DISCLOSURE

Currently, in a game battle, a user can view real-time data of another user in the game battle.

Taking a strategic chess and card game as an example, during a battle of a user with an opposing user, the user can switch the current battle view to the battle view of another user by clicking on the avatar of another user. At this time, a user interface is correspondingly switched from the battle interface of the user to the battle interface of the other user, such that the user can view real-time data of the other user in a battle.

However, in the above related technology, because a battle view needs to be switched to display real-time data of another user in a battle, the display process of the real-time data is complicated.

### SUMMARY

Embodiments of this application provide a display method and apparatus for real-time battle information, a terminal, and a storage medium, which can reduce the complexity of real-time data, thereby improving the display efficiency of the real-time data, and reducing the pressure on a user interface to display the real-time data. Technical solutions are as follows:

According to an aspect of the embodiments of this application, provided is a method for displaying real-time battle information, the method being performed by a terminal, and the method including:

displaying a user interface of a battle;

displaying, within the user interface of the battle, identifiers of user accounts participating in the battle, the identifier of each user account having a display region and the display region comprising a plurality of sub-regions, different sub-regions corresponding to different information categories; and

in response to an operation on a target sub-region in a display region of a target identifier, displaying real-time battle information of a target information category of a target user account corresponding to the target identifier, the target information category being an information category corresponding to the target sub-region.

According to an aspect of the embodiments of this application, provided is a terminal, including a processor and a memory, the memory storing a computer program, the computer program being loaded and executed by the processor causing the terminal to implement the above display method for real-time battle information.

According to an aspect of the embodiments of this application, provided is a computer-readable storage medium, storing a computer program, the computer program being loaded and executed by a processor of a terminal and causing the terminal to implement the above display method for real-time battle information.

The technical solutions provided in the embodiments of this application can bring the following beneficial effects:

Displaying real-time data of a user account in a battle through real-time battle information is supported, such that in the battle, when an operation on a target sub-region in a display region of a target identifier is detected, a user interface only needs to display real-time battle information of a target information category of a target user account to realize the display of the real-time data, without needing to display all real-time data of the target user account, which reduces the display complexity of the real-time data, thereby improving the display efficiency of the real-time data, and reducing the pressure on the user interface to display the real-time data.

In addition, a display region of an identifier is divided into a plurality of sub-regions, and different sub-regions are associated with different information categories, such that the user interface can display real-time battle information of the different information categories for the different sub-regions, thereby improving the display flexibility and diversity of the real-time data.

### BRIEF DESCRIPTION OF THE DRAWINGS

FIG. 1 is a schematic diagram of a display system for real-time battle information according to an embodiment of this application.

FIG. 2 exemplarily shows a schematic diagram of an obtaining manner for real-time battle information.

FIG. 3 is a flowchart of a display method for real-time battle information according to an embodiment of this application.

FIG. 4 exemplarily shows a schematic diagram of a display manner for real-time battle information.

FIG. 5 is a flowchart of a display method for real-time battle information according to another embodiment of this application.

FIG. 6 is a flowchart of a display method for real-time battle information according to yet another embodiment of this application.

FIG. 7 is a block diagram of a display apparatus for real-time battle information according to an embodiment of this application.

FIG. 8 is a block diagram of a display apparatus for real-time battle information according to another embodiment of this application.

FIG. 9 is a structural block diagram of a terminal according to an embodiment of this application.

### DESCRIPTION OF EMBODIMENTS

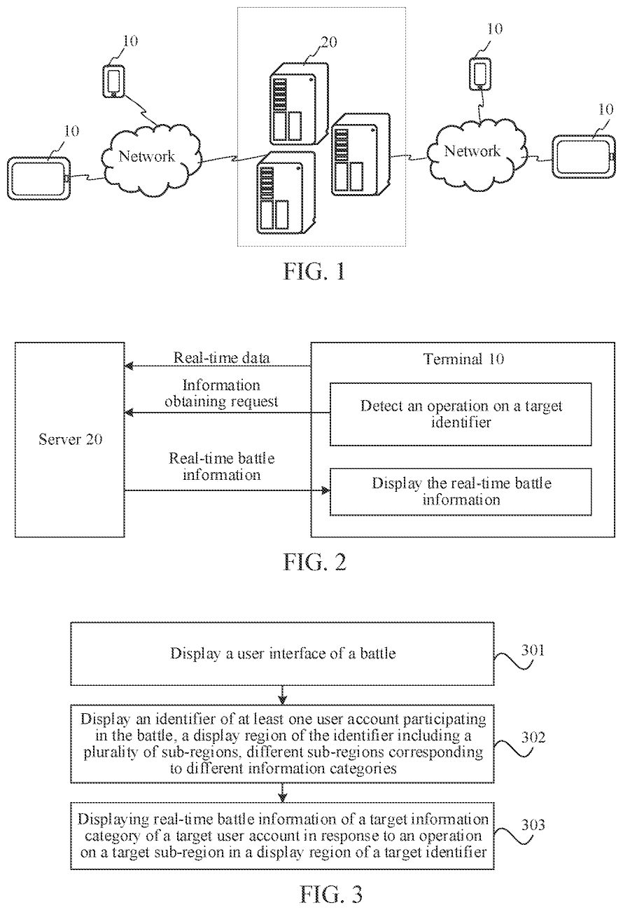

FIG. 1 is a schematic diagram of a display system for real-time battle information according to an embodiment of this application. The display system for real-time battle information may include: a terminal 10 and a server 20.

The terminal 10 may be an electronic device such as a mobile phone, a tablet computer, a game console, an e-book reader, a multimedia playback device, a wearable device, or a Personal Computer (PC). A client of an application (such as a game application), can be installed in the terminal 10. In some embodiments, the application may be an application needing to be downloaded and installed, or a click-to-run application, which is not limited in embodiments of this application.

In the embodiments of this application, the application is any application that can implement a battle. Exemplarily, the application may be a strategic chess and card game, a strategic chess and card game, a Multiplayer Online Battle Arena (MOBA) game, a Third-Person Shooting (TPS) game, a First-Person Shooting (FPS) game, a multiplayer gun war survival game, a Virtual Reality (VR) shooting application, an Augmented Reality (AR) application, a three-dimensional map application, a social application, an interactive entertainment application, or the like. In addition, for different applications, the forms of virtual characters provided thereby will also be different, and corresponding functions will also be different, which can be pre-configured according to actual requirements, and are not limited in the embodiments of this application. Of course, in an exemplary embodiment, a variety of virtual characters having different functions can be provided for a user by the same application, which is not limited in the embodiments of this application.

The virtual characters are virtual characters controlled by the user in the application. Taking the application being a game application as an example, the virtual characters are game characters controlled by the user in the game application. The virtual characters may be in the form of a person, or may be in the form of an animal, a cartoon or other forms, which is not limited in the embodiments of this application. The virtual characters may be displayed in a three-dimensional form, or may be displayed in a two-dimensional form, which is not limited in the embodiments of this application. In some embodiments, in a battle, a user can control a plurality of virtual characters.

The server 20 is configured to provide a backend service for the client of the application in the terminal 10. For example, the server 20 may be a backend server of the application. The server 20 may be one server, a server cluster composed of a plurality of servers, or a cloud computing service center. In some embodiments, the server 20 provides backend services for applications in a plurality of terminals 10 simultaneously.

The terminal 10 and the server 20 can communicate with each other via a network.

In the embodiments of this application, the server 20 can be configured to provide an information recording function for the terminal 10. Exemplarily, as shown in FIG. 2, the terminal 10 sends real-time data of a user account in a battle to the server 20, correspondingly, the server 20 receives the real-time data from the terminal 10, and at the same time, the server 20 also receives real-time data from other terminals. Then, in response to detecting an operation on a target identifier, the terminal 10 sends an information obtaining request to the server 20, then obtains real-time battle information of the target user account, and displays the real-time battle information. The real-time battle information is used for displaying the real-time data of the user account in the battle. In some embodiments, in response to detecting an operation on a target sub-region in a display region of the target identifier, the terminal 10 sends an information obtaining request to the server 20, then obtains real-time battle information of a target information category of the target user account, and displays the real-time battle information of the target information category.

FIG. 3 is a flowchart of a display method for real-time battle information according to an embodiment of this application. The method can be applied to the terminal 10 of the display system for real-time battle information shown in FIG. 1. For example, the subject of execution of each step may be a client of the application installed in the terminal 10. The method may include the following steps (301-303):

Step 301: Display a user interface of a battle.

The battle refers to a situation in which virtual characters in different camps compete with each other, and the battle in embodiments of this application can also be called a competitive battle. The battle may be a game battle, such as a battle in a game application. The battle includes virtual characters in at least two camps, and the numbers of virtual characters in different camps may be the same or different. Of course, in an exemplary embodiment, virtual characters included in different camps of the same battle may have the same or different functions. In some embodiments, at least one user account participating in the battle is in an adversarial relationship, and each user account can be matched with its own virtual character. The battle may be the battle provided by the application in the above embodiments, such as a strategic chess and card game, an MOBA game, TPS, FPS, or a multiplayer gun war survival game.

In the embodiments of this application, after the battle is started, the client displays the user interface of the battle. The user interface displays the battle situation of virtual characters in different camps, that is, the user interface displays real-time data of the battle, where the real-time data may be some real-time data obtained from the current battle. Exemplarily, the real-time data may be data that can change in the battle, such as virtual environment data, virtual resource data, virtual character data, or battle progress data. For example, a client on which a first user account is logged displays real-time data of the battle in the user interface in the battle view of the first user account, and the user interface displays virtual character data change data corresponding to the first user account, virtual character data change data of a second user account in an adversarial relationship with the first user account, battle progress data and virtual resource data change data, etc.

In some embodiments, in different applications, the user interface displays different real-time data. Exemplarily, in the strategic chess and card game (such as an auto chess game), the real-time data displayed in the user interface includes data of users who are in the battle, and data of the virtual character controlled by each user account, and strategic layout data of the virtual character. In the MOBA game, the real-time data displayed by the user interface includes the virtual environment data, the virtual character data in the virtual environment, virtual item data, or the like. In a shooting game, the real-time data displayed by the user interface includes the virtual environment data, the virtual character data in the virtual environment, virtual firearm data of the virtual character, or the like.

Step 302: Display, within the user interface of the battle, an identifier of at least one user account participating in the battle, a display region of the identifier including a plurality of sub-regions, different sub-regions corresponding to different information categories.

In some embodiments, the battle is a battle in which a plurality of users participate together. The maximum numbers of participants in battles in different applications may be the same or different. The maximum numbers of participants in different battles of the same application may be the same or different. In some embodiments, the maximum numbers of participants in battles can be flexibly set and adjusted according to actual situations, which is not limited in the embodiments of this application. Of course, in an exemplary embodiment, before a battle is started, a user can flexibly limit the number of participants in the present battle according to requirements, where the number of the participants is less than the maximum number of participants.

In the embodiments of this application, after displaying the user interface of the battle, the client displays the identifier of the at least one user account participating in the battle. In some embodiments, after displaying the user interface of the battle, the client obtains the at least one user account participating in the battle and then displays the identifier of the at least one user account. The identifier is used for indicating a unique user account, and the identifier in the embodiments of this application may also be referred to as a user identifier. Exemplarily, the identifier includes, but is not limited to, at least one of the following: an avatar, a name, a hit point, an attack value, a defense value, etc.

In the embodiments of this application, the client can directly display the identifier of the at least one user accounts while displaying the user interface; or, the client may also display the identifier of the at least one user account after displaying the user interface and receiving an identifier display instruction. The identifier display instruction may be an instruction triggered by the user according to situations, or an instruction automatically triggered by the client according to actual situations.

In some embodiments, the at least one user account may be user accounts of all users participating in the battle, or user accounts of some of users participating in the battle.

In a possible implementation, the at least one user account is the user accounts of all the users participating in the battle. In some embodiments, when displaying the identifier of the at least one user account, the client determines all the user accounts participating in the battle, and displays identifiers of all the user accounts.

In another possible implementation, the at least one user account is user accounts of some of the users participating in the battle. In some embodiments, when displaying the identifier of the at least one user account, the client determines the user accounts participating in the battle, then selects, from the user accounts, at least one user account that satisfies a condition, and displays an identifier of the user account that satisfies the condition. The condition includes, but is not limited to, at least one of the following: the distance between a virtual character controlled by another user account and a virtual object controlled by the first user account is less than a threshold, the other user account has permission to battle with the first user account, the other user account has a particular item, the virtual character controlled by the other user account executes a particular behavior, etc. The first user account is a user account of a user of the client, and the threshold may be any value, and can be flexibly set and adjusted according to actual situations, which is not limited in the embodiments of this application. The user accounts may or may not include the first user account, which is not limited in the embodiments of this application. Thus, by only displaying the user account that satisfies the condition, the user interface does not need to display all the user accounts, thereby reducing the pressure on the user interface to display the battle. In addition, because the client directly displays screened user accounts, and manual screening is not required, the difficulty and complexity of obtaining useful information are reduced, thereby facilitating improvement of the convenience and efficiency of obtaining the useful information.

In the embodiments of this application, an information category refers to a category of information, and real-time battle information can be divided into a plurality of information categories according to actual use requirements. The display region of the identifier can be divided into a plurality of sub-regions according to content corresponding to the identifier, such as an avatar, a name, a hit point, an attack value, and a defense value.

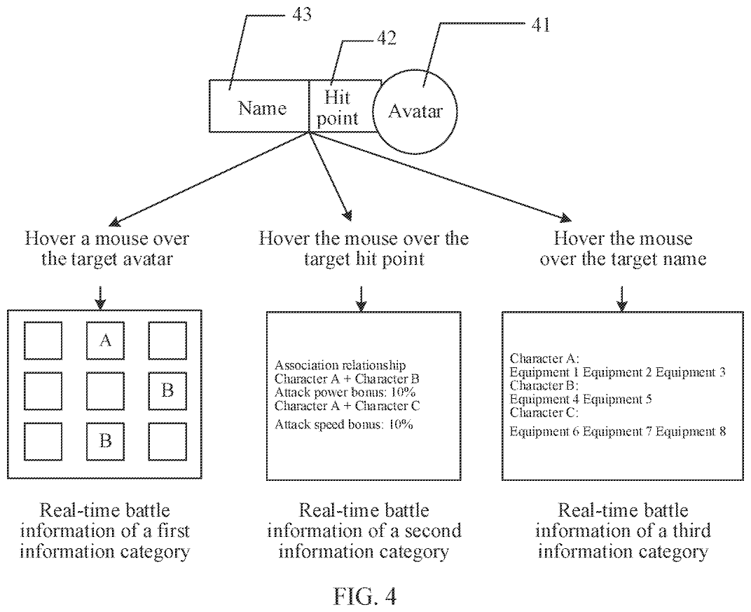

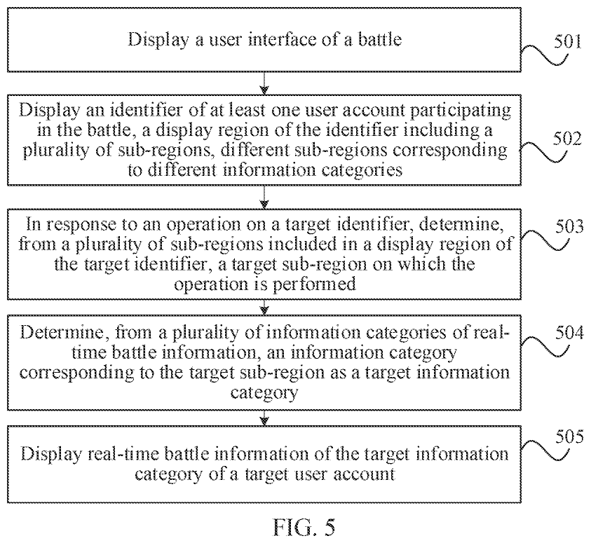

Exemplarily, referring to FIG. 4, a display region of a target identifier includes three sub-regions, i.e., a target avatar 41, a target hit point 42, and a target name 43. When a user hovers a mouse over the target avatar 41, a client determines that real-time battle information is real-time battle information of a first information category; when the user hovers the mouse over the target name 43, the client determines that the real-time battle information is real-time battle information of a second information category; and when the user hovers the mouse over the target hit point 42, the client determines that the real-time battle information is real-time battle information of a third information category. The real-time battle information of the first information category can be used for displaying virtual characters controlled by a user account in a battle and arrangement position information of the virtual characters (i.e., real-time battle information corresponding to the strategic layout data above); the real-time battle information of the second information category can be used for displaying an association relationship between virtual objects controlled by the user account in the battle; and the real-time battle information of the third information category can be used for displaying a virtual resource owned by the user account in the battle, such as virtual equipment.

The real-time battle information is divided into information of a plurality of (such as three) information categories, and different sub-regions are associated with different information categories, the user interface can display real-time battle information of the different information categories for the different sub-regions, thereby improving the display flexibility and diversity of real-time data. Furthermore, the user interface provides the different information categories for the user to select, thereby further improving the viewing flexibility and freedom of the real-time data. In addition, by associating the information category with a sub-region corresponding to a display region of a target user identifier, a rapid selection entry of information category is provided for the user, thereby ensuring the rapidity of information category selection, thus improving user experience.

Step 303: Display real-time battle information of a target information category of a target user account in response to an operation on a target sub-region in a display region of a target identifier.

In the embodiments of this application, after displaying the identifier of the at least one user account, the client detects a display region of each identifier, in response to detecting the operation on the target sub-region in the display region of the target identifier, the client displays the real-time battle information of the target information category of the target user account. The target user account is a user account corresponding to the target identifier, the target information category is an information category corresponding to the target sub-region, the target sub-region may be any one of the plurality of sub-regions, the real-time battle information is used for displaying the real-time data of the user account in the battle, and the target user account is any one of the at least one user account. In some embodiments, the operation may be a click operation, a slide operation, a mouse hovering operation, a gesture operation, a voice operation, or the like, which is not limited in the embodiments of this application.

Exemplarily, after detecting the operation, the client can obtain, according to an operation position corresponding to the operation, a sub-region on which the operation is performed, then determines as the target information category corresponding to the real-time match information an information category corresponding to the sub-region on which the operation is performed, and displays the real-time battle information of the target user account under the target information category. For example, assuming that the display region of the target identifier includes a first sub-region, a second sub-region, and a third sub-region, in response to an operation on the first sub-region by the user, the client determines an information category corresponding to the first sub-region as the target information category corresponding the real-time battle information.

In an example, when the operation is a slide operation, the client obtains a slide trajectory of the slide operation after detecting the slide operation on the target identifier, further, determines, according to a sub-region through which the slide trajectory passes, an information category corresponding to the sub-region as an information category corresponding to the real-time battle information, and displays the real-time battle information of the target user account according to the information category corresponding to the real-time battle information.

For example, assuming that the display region of the target identifier includes the first sub-region, the second sub-region, and the third sub-region, when the slide trajectory of the slide operation includes the first sub-region and the second sub-region, the client determines information categories corresponding to the first sub-region and the second sub-region as information categories corresponding to the real-time battle information, and at the same time, displays real-time battle information of the information category corresponding to the first sub-region and real-time battle information of the information category corresponding to the second sub-region. The user interface supports determining an information category corresponding to the real-time battle information through the slide trajectory, which can further improve the display flexibility and diversity of the real-time data, and can improve the flexibility and freedom of the user to select the information category.

In some embodiments, in response to determining to display the real-time battle information of the target information category of the target user account, the client sends an information obtaining request to a server, and the server sends the real-time battle information of the target information category of the target user account to the client according to the information obtaining request. The information obtaining request includes mark information of the target user account and an information category of the real-time battle information (i.e., the target information category).

In some embodiments, when displaying the real-time battle information of the target information category of the target user account, the client may keep displaying real-time data of the first user account in the battle in the user interface. Exemplarily, the client still displays, in the user interface, in the battle view of the first user account the battle situation in which the first user account participates, and at the same time displays the real-time battle information of the target information category of the target user account in the user interface. In some embodiments, the real-time battle information can be displayed at any position or at a calculated position according to a set rule, which is not limited in the embodiments of this application.

In summary, in technical solutions provided by the embodiments of this application, displaying real-time data of a user account in a battle through real-time battle information is supported, such that in the battle, when an operation on a target sub-region in a display region of a target identifier is detected, a user interface only needs to display real-time battle information of a target information category of a target user account to realize the display of the real-time data, without needing to display all real-time data of the target user account, which reduces the display complexity of the real-time data, thereby improving the display efficiency of the real-time data, and reducing the pressure on the user interface to display the real-time data.

In addition, a display region of an identifier is divided into a plurality of sub-regions, and different sub-regions are associated with different information categories, such that the user interface can display real-time battle information of the different information categories for the different sub-regions, thereby improving the display flexibility and diversity of the real-time data.

In addition, the real-time data of the user account in the battle is intuitively displayed through the real-time battle information, thereby improving the obtaining convenience of the real-time data. Furthermore, by providing selection methods for the different information categories, the obtaining flexibility and freedom of the real-time data is improved.

In addition, because the client does not need to switch to a battle interface of the target user account such that a user obtains the real-time data of the target user account in the battle, the display path of the real-time data is shortened and the display complexity of the real-time data is reduced, thereby further reducing pressure on the user interface to display the real-time data, and improving the display efficiency of the real-time data. Furthermore, improvement of the efficiency of obtaining the real-time data by the user is facilitated. Meanwhile, when real-time data of a plurality of user accounts needs to be viewed, because there is no need to frequently switch the battle interface, the obtaining complexity of the real-time data is reduced while reducing the pressure on the user interface to display the real-time data.

A display manner for real-time battle information will be introduced below.

In a possible implementation, real-time battle information of different user accounts is displayed at the same position. In some embodiments, the user interface includes a display region of the real-time battle information, when displaying the real-time battle information of the target user account, the client determines whether real-time battle information of another user account is displayed in the display region of the real-time battle information. When the real-time battle information of another user account is displayed in the display region of the real-time battle information, the real-time battle information of the other user account is switched to the real-time battle information of the target user account. When no real-time battle information of another user account is displayed in the display region of the real-time battle information, the real-time battle information of the target user account is directly displayed in the display region of the real-time battle information. By displaying the real-time battle information at the same position, the user does not need to search for the real-time battle information again when the real-time battle information is switched, thereby further improving the efficiency of obtaining the real-time battle information by the user. Moreover, display planning of the real-time battle information is facilitated, the client does not need to frequently determine the display region of the real-time battle information, thereby reducing the workload required for the display of the real-time battle information.

In another possible implementation, the real-time battle information of the different user accounts is displayed at different display positions, and the display position of the real-time battle information is related to the display position of the identifier of the user account. In some embodiments, step 303 includes the following steps:

1. Obtain a display position of the target identifier.

In some embodiments, the client obtains the display position of the target identifier in response to determining to display the real-time battle information of the target user account.

2. Determine the display position of the real-time battle information based on the display position of the target identifier.

In some embodiments, after obtaining the display position of the target identifier, the client determines the display position of the real-time battle information based on the display position of the target identifier.

In a possible implementation, after obtaining the display position of the target identifier, the client determines a position close to the display position of the target identifier as the display position of the real-time battle information.

In another possible implementation, in order to prevent viewing of the real-time data of the battle by the user from being affected by the real-time battle information when displayed, after obtaining the display position of the target identifier, the client determines at least one candidate display position. Further, the client determines, from the at least one candidate display position, a candidate display position closest to the display position of the target identifier as the display position of the real-time battle information.

In some embodiments, the candidate display position refers to a position where a particular display element in the user interface is not blocked, such as a display element corresponding to the real-time data of the first user account in the battle. In a possible implementation, during obtaining of the candidate display position, the client segments the user interface based on the minimum size of complete display of the real-time battle information to obtain a plurality of candidate regions, and then determines as the candidate display position a candidate region in which a particular display element is not displayed. In another possible implementation, during the obtaining of the candidate display position, the client obtains a display position of a particular display element, and using the display position of the particular display element as a segmentation basis, determines as the candidate display position the position remaining after the user interface is segmented. For example, using as the segmentation basis the battle situation in which the first user account participates, the position remaining after the user interface is segmented is determined as the candidate display position. Thus, the battle situation in which the first user account participates may not be blocked, thereby not affecting obtaining of real-time data of the user in the battle by the user.

The particular display element may be an important display element in the battle. In some embodiments, different applications correspond to different particular display elements. Exemplarily, in the strategic chess and card game, the particular display element may include the data of the virtual character controlled by the each user account and the strategic layout data of the virtual character. In the MOBA game, the particular display element may include the virtual character data in the virtual environment, the virtual item data, etc. In the shooting game, the particular display element may include the virtual firearm data of the virtual character, etc.

In some embodiments, the distance refers to a distance between a center point of the display position of the target identifier and a center point of the candidate display region; or, the distance refers to the closest distance between the center point of the display position of the target identifier and an edge point of the candidate display region.

In some embodiments, the real-time battle information of the target information category of the target user account is displayed at the display position of the real-time battle information. Exemplarily, after obtaining the display position of the real-time battle information, the client displays the real-time battle information of the target information category of the target user account at the display position of the real-time battle information. In some embodiments, the real-time battle information can be displayed at the corresponding display position in the form of a pop-up window. In an exemplary embodiment, the real-time battle information can also be displayed at the corresponding display position in other forms, such as a bubble form, and a special effect form.

By associating the display position of the real-time battle information with the display position of identifier of the user account, the client can calculate a reasonable display position of the real-time battle information more easily, thereby improving the display reasonability of the real-time battle information. Meanwhile, the user can obtain an association between the real-time battle information and the user account more easily, and the user can obtain real-time battle information of each user account in an orderly manner and accurately, thereby avoiding incorrect pairing of the real-time battle information with the user account, thus further improving the user experience.

FIG. 5 is a flowchart of a display method for real-time battle information according to another embodiment of this application. The method can be applied to the terminal 10 of the display system for real-time battle information shown in FIG. 1. For example, the subject of execution of each step may be a client of the application installed in the terminal 10. The method may include the following steps (501-505):

Step 501: Display a user interface of a battle.

Step 502: Display, within the user interface of the battle, an identifier of at least one user account participating in the battle, a display region of the identifier including a plurality of sub-regions, different sub-regions corresponding to different information categories.

Steps 501 and 502 are the same as steps 301 and 302 in the embodiment of FIG. 3. For details, reference is made to the embodiment of FIG. 3. Details are not described herein again.

Step 503: In response to an operation on a target identifier, determine, from a plurality of sub-regions included in a display region of the target identifier, a target sub-region on which the operation is performed.

In some embodiments, in response to the operation on the target identifier, attribute information of the operation is obtained, and according to the attribute information of the operation, the target sub-region on which the operation is performed is determined from the plurality of sub-regions included in the display region of the target identifier. In embodiments of this application, after displaying the identifier of the at least one user account, the client detects each identifier, and in response to detecting the operation on the target identifier, obtains the attribute information of the operation. The attribute information is used for indicating an operation attribute of the operation. Exemplarily, the attribute information includes, but is not limited to, at least one of the following: a trigger position of the operation, an operation method for the operation, the number of triggers of the operation, a trigger duration of the operation, a trigger distance of the operation, etc.

In some embodiments, different operations correspond to different attribute information. Exemplarily, when the operation is a click operation, the attribute information is the trigger position of the operation (click position) and/or the number of triggers of the operation (number of clicks); when the operation is a long-time press operation, the attribute information is the trigger duration of the operation (press operation); and when the operation is a slide operation, the attribute information is the trigger distance of the operation (slide distance).

For example, when the operation is a click operation, the target sub-region on which the operation is performed may be determined from the plurality of sub-regions included in the display region of the target identifier according to the trigger position of operation. The target sub-region on which the operation is performed may also be determined from the plurality of sub-regions included in the display region of the target identifier according to the number of triggers of the operation.

Step 504: Determine, from a plurality of information categories of real-time battle information, an information category corresponding to the target sub-region as a target information category.

In some embodiments, the different sub-regions corresponding to the different information categories. In the embodiments of this application, after obtaining the target sub-region, the client determines, from the plurality of information categories of the real-time battle information, a target information category corresponding to the target sub-region.

Step 505: Display real-time battle information of a target information category of a target user account.

In some embodiments, after obtaining the target information category, the client obtains the real-time battle information of the target information category of the target user account. Exemplarily, during the obtaining of the real-time battle information of the target information category, the client sends an information obtaining request to a server, and then the server sends the real-time battle information of the target information category to the client according to the information obtaining request. The information obtaining request includes identifier information and the target information category of the target user account.

In the embodiments of this application, after obtaining the real-time battle information of the target information category of the target user account, the client displays the real-time battle information of the target information category of the target user account.

In the embodiments of this application, the real-time battle information may display real-time data in the form of text information or in the form of an image. Exemplarily, as shown in FIG. 4, real-time battle information of a first information category is displayed in the form of a thumbnail corresponding to strategic layout data.

In summary, in technical solutions provided in the embodiments of this application, the display region of the identifier is divided into a plurality of sub-regions, and different sub-regions are associated with different information categories, such that a user interface can display real-time battle information of the different information categories for the different sub-regions, thereby improving the display flexibility and diversity of real-time data. In addition, different sub-regions on which an operation is performed correspond to real-time battle information of different information categories, and when a user triggers an operation on a target user identifier, the user can view the real-time battle information of the different information categories by triggering the operation on the different sub-regions according to actual situations, such that the user can view required real-time battle information flexibly and freely.

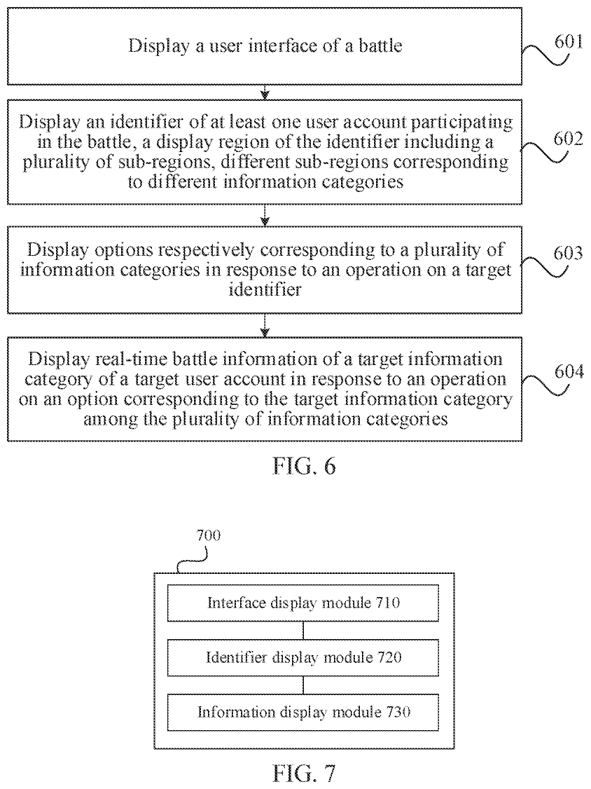

FIG. 6 is a flowchart of a display method for real-time battle information according to yet another embodiment of this application. The method can be applied to the terminal 10 of the display system for real-time battle information shown in FIG. 1. For example, the subject of execution of each step may be a client of the application installed in the terminal 10. The method may include the following steps (601-604):

Step 601: Display a user interface of a battle.

Step 602: Display, within the user interface of the battle, an identifier of at least one user account participating in the battle, a display region of the identifier including a plurality of sub-regions, different sub-regions corresponding to different information categories.

Steps 601 and 602 are the same as steps 301 and 302 in the embodiment of FIG. 3. For details, reference is made to the embodiment of FIG. 3. Details are not described herein again.

Step 603: Display options respectively corresponding to a plurality of information categories in response to an operation on a target identifier.

In embodiments of this application, after displaying the identifier of the at least one user account, the client detects each identifier, and in response to detecting the operation on the target identifier, displays the options respectively corresponding to the plurality of information categories. The options are used for receiving selection operations on the information categories by a user. Exemplarily, in response to a double-click operation on a display region of the target identifier by the user, the options respectively corresponding to the plurality of information categories are displayed, but not an information category corresponding to a sub-region on which the double-click operation is performed is directly determined as a target information category. An operation method for displaying the options is different from an operation method for directly determining an information category according to a sub-region, and can be set and adjusted by the user according to actual use requirements. Through different operation methods, information categories can be selected through different selection methods, thereby improving the selection flexibility and freedom of the user.

In some embodiments, a display order of the options respectively corresponding to the plurality of information categories may be fixed or variable.

In a possible implementation, the display order of the options respectively corresponding to the plurality of information categories is fixed. In some embodiments, when displaying the options respectively corresponding to the plurality of information categories, the client displays the options respectively corresponding to the plurality of information categories in the fixed display order.

In another possible implementation, the display order of the options respectively corresponding to the plurality of information categories is variable. In some embodiments, when displaying the options respectively corresponding to the plurality of information categories, the client obtains historical selection information of the plurality of information categories. Further, the client determines the display order of the options respectively corresponding to the plurality of information categories according to the historical selection information, and displays the options respectively corresponding to the plurality of information categories in the display order.

The historical selection information is used for indicating historical selection data of the user for each information category. In a possible implementation, the historical selection information includes the numbers of selections respectively corresponding to the plurality of information categories, and a chronological display order of the options corresponding to the information categories is determined based on the order of descending the numbers of selections corresponding to the information categories. In another possible implementation, the historical selection information includes the most recent selection moments respectively corresponding to the plurality of information categories, a reverse chronological display order of the options corresponding to the information categories is determined based on a sequential order of the most recent selection moments corresponding to the information categories. By ordering and displaying the options of the plurality of information categories according to the historical selection information, the display of the options is more in line with the viewing habit of the user, thereby improving user experience. Furthermore, the display order of the options is determined according to the numbers of selections or the selection moments, and an information category that the user may need to view can be displayed first, thereby further improving the user experience.

In some embodiments, the historical selection information may be obtained by the client according to the historical selection data of the user for each information category in this battle; or, the historical selection information may also be obtained by the client according to the historical selection data of the user for each information category in a historical battle; or, the historical selection information may also be obtained by the client according to the historical selection data of the user for each information category in the historical battle and the present battle.

In some embodiments, when displaying the options respectively corresponding to the plurality of information categories in the display order, the client may directly display the plurality of options in the user interface in the display order, or may switch and display the plurality of options one by one in the display order.

A determining method for display positions of the options respectively corresponding to the plurality of information categories is similar to a determining method for the display position of the real-time battle information above. For details, reference is made to the introduction above. Details are not described herein again.

Step 604: Display real-time battle information of a target information category of a target user account in response to an operation on an option corresponding to the target information category among the plurality of information categories.

In some embodiments, after displaying the options respectively corresponding to the plurality of information categories, the client detects each option, and in response to detecting the operation on the option corresponding to the target information category among the plurality of information categories, obtains the real-time battle information of the target information category of the target user account.

In some embodiments, the plurality of information categories include a first information category, a second information category, and a third information category. Real-time battle information of the first information category is used for displaying virtual characters controlled by the user account in the battle and arrangement position information of the virtual characters; real-time battle information of the second information category is used for displaying an association relationship between virtual objects controlled by the user account in the battle; and real-time battle information of the third information category is used for displaying a virtual resource owned by the user account in the battle.

The display method for real-time battle information is the same as step 505 in the embodiment of FIG. 5. For details, reference is made to the embodiment of FIG. 5. Details are not described herein again.

In summary, in technical solutions provided by the embodiments of this application, a client displays an option for a user to select an information category, thereby improving the display intuitiveness of real-time data, and during viewing of real-time battle information of a target user account, the user can directly select an information category of the real-time battle information through the option, such that the user can view the real-time battle information under the required information category more intuitively, flexibly and freely.

The following describes apparatus embodiments of this application, which can be used for executing the method embodiments of this application. For details not disclosed in the apparatus embodiments of this application, reference is made to the method embodiments of this application.

FIG. 7 is a block diagram of a display apparatus for real-time battle information according to an embodiment of this application. The apparatus has functions of implementing the above display method for real-time battle information, and the functions may be implemented by hardware or may be implemented by hardware executing corresponding software. The apparatus may be a terminal, or may be provided in a terminal. The apparatus 700 may include: an interface display module 710, an identifier display module 720, and an information display module 730.

The interface display module 710 is configured to display a user interface of a battle.

The identifier display module 720 is configured to display an identifier of at least one user account participating in the battle, a display region of the identifier including a plurality of sub-regions, different sub-regions corresponding to different information categories.

The information display module 730 is configured to display real-time battle information of a target information category of a target user account in response to an operation on a target sub-region in a display region of a target identifier, the target user account being a user account corresponding to the target user identifier, the target information category being an information category corresponding to the target sub-region, and the real-time battle information being used for displaying real-time data of the user account in the battle.

In an exemplary embodiment, the information display module 730 is configured to:

in response to the operation on the target identifier, determine, from a plurality of sub-regions included in the display region of the target identifier, the target sub-region on which the operation is performed;

determine, from a plurality of information categories of the real-time battle information, an information category corresponding to the target sub-region as the target information category; and

display the real-time battle information of the target information category of the target user account.

In an exemplary embodiment, the plurality of information categories include a first information category, a second information category, and a third information category, real-time battle information of the first information category being used for displaying virtual characters controlled by the user account in the battle and arrangement position information of the virtual characters; real-time battle information of the second information category being used for displaying an association relationship between virtual objects controlled by the user account in the battle; and real-time battle information of the third information category being used for displaying a virtual resource owned by the user account in the battle.

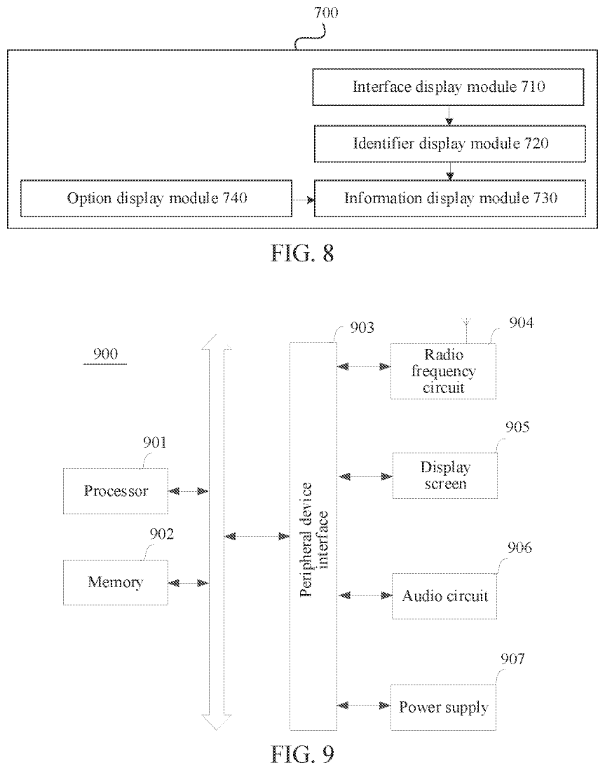

In an exemplary embodiment, as shown in FIG. 8, the apparatus 700 further includes: an option display module 740.

The option display module 740 is configured to display options respectively corresponding to the plurality of information categories in response to the operation on the target identifier.

The information display module 730 is further configured to perform an operation of displaying the real-time battle information of the target information category of the target user account in response to an operation on an option corresponding to the target information category among the plurality of information categories.

In an exemplary embodiment, the option display module 740 includes: an information obtaining sub-module, an order determining sub-module, and an option display sub-module (not shown in FIG. 8).

The information obtaining sub-module is configured to obtain historical selection information of the plurality of information categories.

The order determining sub-module is configured to determine a display order of the options respectively corresponding to the plurality of information categories according to the historical selection information.

The option display sub-module is configured to display the options respectively corresponding to the plurality of information categories in the display order.

In an exemplary embodiment, the order determining sub-module is configured to: the historical selection information including the numbers of selections respectively corresponding to the plurality of information categories, determine a chronological display order of the options corresponding to the information categories based on the order of descending the numbers of selections corresponding to the information categories; or, the historical selection information including the most recent selection moments respectively corresponding to the plurality of information categories, determine a reverse chronological display order of the options corresponding to the information categories based on a sequential order of the most recent selection moments corresponding to the information categories.

In an exemplary embodiment, the information display module 730 is further configured to determine a display position of the real-time battle information based on a display position of the target identifier, the real-time battle information of the target information category of the target user account being displayed at the display position of the real-time battle information.

In an exemplary embodiment, the information display module 730 is further configured to determine at least one candidate display position, the candidate display position referring to a position where a particular display element in the user interface is not blocked; and determine, from the at least one candidate display position, a candidate display position closest to the display position of the target identifier as the display position of the real-time battle information.

In an exemplary embodiment, the identifier display module 720 is configured to determine user accounts participating in the battle; select, from the user accounts, at least one user account that satisfies a condition; and display an identifier of the user account that satisfies the condition.

In an exemplary embodiment, the information display module 730 is further configured to obtain a slide trajectory of a slide operation in response to the slide operation on the target identifier; determine, according to a sub-region through which the slide trajectory passes, an information category corresponding to the sub-region as an information category corresponding to the real-time battle information; and display the real-time battle information of the target user account according to the information category corresponding to the real-time battle information.

In summary, in technical solutions provided by the embodiments of this application, displaying real-time data of a user account in a battle through real-time battle information is supported, such that in the battle, when an operation on a target sub-region in a display region of a target identifier is detected, a user interface only needs to display real-time battle information of a target information category of a target user account to realize the display of the real-time data, without needing to display all real-time data of the target user account, which reduces the display complexity of the real-time data, thereby improving the display efficiency of the real-time data, and reducing the pressure on the user interface to display the real-time data.

In addition, a display region of an identifier is divided into a plurality of sub-regions, and different sub-regions are associated with different information categories, such that the user interface can display real-time battle information of the different information categories for the different sub-regions, thereby improving the display flexibility and diversity of the real-time data.

In the apparatus provided in the above embodiments, during implementation of the functions thereof, only division of the above functional modules is taken as an example for description. In practical application, the above functions may be allocated to different functional modules according to requirements, that is, the internal structure of a device is divided into different functional modules, to complete all or some of the above-mentioned functions. In addition, the apparatus provided in the above embodiments and the method embodiments belong to a same concept. For a specific implementation process, reference is made to the method embodiments. Details are not described herein again.

FIG. 9 is a structural block diagram of a terminal 900 according to an embodiment of this application. The terminal 900 may be an electronic device such as a mobile phone, a tablet computer, a game console, an e-book reader, a multimedia playback device, a wearable device, or a PC. The terminal is configured to implement the display method for real-time battle information provided in the above embodiments. The terminal may be a terminal 10 of a game running environment shown in FIG. 1. Specifically:

In general, the terminal 900 includes: a processor 901 and a memory 902.

The processor 901 may include one or more processing cores, for example, a 4-core processor or an 8-core processor. The processor 901 may be implemented in at least one hardware form of a Digital Signal Processing (DSP), a Field Programmable Gate Array (FPGA), and a Programmable Logic Array (PLA). The processor 901 may also include a main processor and a coprocessor. The main processor is a processor configured to process data in an awaken state, and is also referred to as a Central Processing Unit (CPU). The coprocessor is a low-power-consumption processor configured to process data in a standby state. In some embodiments, the processor 901 may be integrated with a Graphics Processing Unit (CPU), the GPU being configured to render and draw content that needs to be displayed on a display screen. In some embodiments, the processor 901 may further include an Artificial Intelligence (AI) processor, the AI processor being configured to process computing operations related to machine learning.

The memory 902 may include one or more computer-readable storage media. The computer-readable storage medium may be non-transitory. The memory 902 may further include a high-speed random access memory and a non-volatile memory, for example, one or more disk storage devices or flash storage devices. In some embodiments, the non-transitory computer-readable storage medium in the memory 902 is configured to store a computer program, the computer program being configured to be executed by one or more processors to implement the above display method for real-time battle information.

In some embodiments, the terminal 900 further includes: a peripheral device interface 903 and at least one peripheral device. The processor 901, the memory 902, and the peripheral device interface 903 may be connected through a bus or a signal wire. Each peripheral may be connected to the peripheral device interface 903 through a bus, a signal wire, or a circuit board. Specifically, the peripheral device includes: at least one of a radio frequency circuit 904, a display screen 905, an audio circuit 906, and a power supply 907.

A person skilled in the art may understand that the structure shown in FIG. 9 does not constitutes a limitation on the terminal 900, and the terminal may include more or fewer components than those shown in the drawing, or some components may be combined, or a different component arrangement may be used.

In an exemplary embodiment, further provided is a computer-readable storage medium, storing a computer program, the computer program being executed by a processor to implement the above display method for real-time battle information.

In some embodiments, the computer-readable storage medium may include: a Read Only Memory (ROM), a Random Access Memory (RAM), a Solid State Drive (SSD), an optical disk, or the like. The random access memory may include a Resistance Random Access Memory (ReRAM) or a Dynamic Random Access Memory (DRAM).

In an exemplary embodiment, further provided is a computer program product or a computer program, including a computer instruction stored in a computer-readable storage medium, and a processor reading the computer instruction from the computer-readable storage medium and executing the computer instruction to implement the above display method for real-time battle information.

Information (including, but not limited to, object device information, object personal information, and the like), data (including, but not limited to, data used for analysis, stored data, displayed data, and the like), and signals involved in this application are all authorized by objects or fully authorized by all parties, and collection, use, and processing of related data need to comply with relevant laws, regulations, and standards of relevant countries and regions. For example, the user accounts, the real-time battle information, and the like involved in this application are obtained in a case of full authorization.

“Plurality of” mentioned in herein means two or more. “And/or” describes an association relationship between associated objects and represents that there may be three relationships, for example, A and/or B, which may be: only A, both A and B, and only B. The character “/” generally indicates an “or” relationship between the sequentially associated objects. In addition, the step numbers described herein merely exemplarily show a possible execution order of the steps. In some other embodiments, the steps may not be performed in the order of the numbers, for example, two steps with different numbers may be performed simultaneously, or two steps with different numbers may be performed in an order opposite to the order in the drawing, which is not limited in the embodiments of this application.

In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit. The above is merely exemplary embodiments of this application, but is not intended to limit this application. Any modification, equivalent replacement, or improvement made within the spirit and principle of this application shall fall within the scope of protection of this application.

What is claimed is:

1. A method for displaying real-time battle information performed by a terminal, the method comprising:
displaying a user interface of a battle;
displaying, within the user interface of the battle, identifiers of user accounts participating in the battle, the identifier of each user account having a display region and the display region comprising a plurality of sub-regions, different sub-regions corresponding to different information categories; and
in response to an operation on a target sub-region in a display region of a target identifier, displaying real-time battle information of a target information category of a target user account corresponding to the target identifier, the target information category being an information category corresponding to the target sub-region.

2. The method according to claim 1, wherein the displaying real-time battle information of a target information category of a target user account corresponding to the target identifier comprises:
determining, from a plurality of sub-regions comprised in the display region of the target identifier, the target sub-region on which the operation is performed;
determining, from a plurality of information categories of the real-time battle information, an information category corresponding to the target sub-region as the target information category; and
displaying the real-time battle information of the target information category of the target user account.

3. The method according to claim 1, wherein the different information categories comprise a first information category, a second information category, and a third information category,
real-time battle information of the first information category displaying virtual characters controlled by the target user account in the battle and arrangement position information of the virtual characters;
real-time battle information of the second information category displaying an association relationship between the virtual objects controlled by the target user account in the battle; and
real-time battle information of the third information category displaying a virtual resource owned by the target user account in the battle.

4. The method according to claim 1, wherein the method further comprises:
displaying options respectively corresponding to a plurality of information categories in response to the operation on the target identifier; and
performing an operation of displaying the real-time battle information of the target information category of the target user account in response to an operation on an option corresponding to the target information category among the plurality of information categories.

5. The method according to claim 1, wherein the method further comprises:
determining a display position of the real-time battle information based on a display position of the target identifier; and
displaying the real-time battle information of the target information category of the target account at the display position of the real-time battle information.

6. The method according to claim 1, wherein the displaying, within the user interface of the battle, identifiers of user accounts participating in the battle comprises:
determining candidate user accounts participating in the battle;
selecting, from the candidate user accounts, the user accounts satisfying a predefined condition; and
displaying the identifiers of the user accounts that satisfying the predefined condition.

7. The method according to claim 1, wherein the method further comprises:
obtaining a slide trajectory of a slide operation in response to the slide operation on the target identifier;
determine, according to a sub-region through which the slide trajectory passes, an information category corresponding to the sub-region as an information category corresponding to the real-time battle information; and
displaying the real-time battle information of the target user account according to the information category corresponding to the real-time battle information.

8. A terminal, comprising a processor and a memory, the memory storing a computer program, the computer program being loaded and executed by the processor and causing the terminal to perform a method for displaying real-time battle information including:
displaying a user interface of a battle;
displaying, within the user interface of the battle, identifiers of user accounts participating in the battle, the identifier of each user account having a display region and the display region comprising a plurality of sub-regions, different sub-regions corresponding to different information categories; and
in response to an operation on a target sub-region in a display region of a target identifier, displaying real-time battle information of a target information category of a target user account corresponding to the target identifier, the target information category being an information category corresponding to the target sub-region.

9. The terminal according to claim 8, wherein the displaying real-time battle information of a target information category of a target user account corresponding to the target identifier comprises:
determining, from a plurality of sub-regions comprised in the display region of the target identifier, the target sub-region on which the operation is performed;
determining, from a plurality of information categories of the real-time battle information, an information category corresponding to the target sub-region as the target information category; and
displaying the real-time battle information of the target information category of the target user account.

10. The terminal according to claim 8, wherein the different information categories comprise a first information category, a second information category, and a third information category,
real-time battle information of the first information category displaying virtual characters controlled by the target user account in the battle and arrangement position information of the virtual characters;
real-time battle information of the second information category displaying an association relationship between the virtual objects controlled by the target user account in the battle; and
real-time battle information of the third information category displaying a virtual resource owned by the target user account in the battle.

11. The terminal according to claim 8, wherein the method further comprises:
displaying options respectively corresponding to a plurality of information categories in response to the operation on the target identifier; and
performing an operation of displaying the real-time battle information of the target information category of the target user account in response to an operation on an option corresponding to the target information category among the plurality of information categories.

12. The terminal according to claim 8, wherein the method further comprises:
determining a display position of the real-time battle information based on a display position of the target identifier; and
displaying the real-time battle information of the target information category of the target account at the display position of the real-time battle information.

13. The terminal according to claim 8, wherein the displaying, within the user interface of the battle, identifiers of user accounts participating in the battle comprises:
determining candidate user accounts participating in the battle;
selecting, from the candidate user accounts, the user accounts satisfying a predefined condition; and
displaying the identifiers of the user accounts that satisfying the predefined condition.

14. The terminal according to claim 8, wherein the method further comprises:
obtaining a slide trajectory of a slide operation in response to the slide operation on the target identifier;
determine, according to a sub-region through which the slide trajectory passes, an information category corresponding to the sub-region as an information category corresponding to the real-time battle information; and
displaying the real-time battle information of the target user account according to the information category corresponding to the real-time battle information.

15. A non-transitory computer-readable storage medium, storing a computer program, the computer program being loaded and executed by a processor of a terminal and causing the terminal to perform a method for displaying real-time battle information including:
displaying a user interface of a battle;
displaying, within the user interface of the battle, identifiers of user accounts participating in the battle, the identifier of each user account having a display region and the display region comprising a plurality of sub-regions, different sub-regions corresponding to different information categories; and
in response to an operation on a target sub-region in a display region of a target identifier, displaying real-time battle information of a target information category of a target user account corresponding to the target identifier, the target information category being an information category corresponding to the target sub-region.

16. The non-transitory computer-readable storage medium according to claim 15, wherein the displaying real-time battle information of a target information category of a target user account corresponding to the target identifier comprises:
determining, from a plurality of sub-regions comprised in the display region of the target identifier, the target sub-region on which the operation is performed;
determining, from a plurality of information categories of the real-time battle information, an information category corresponding to the target sub-region as the target information category; and
displaying the real-time battle information of the target information category of the target user account.

17. The non-transitory computer-readable storage medium according to claim 15, wherein the different information categories comprise a first information category, a second information category, and a third information category,
real-time battle information of the first information category displaying virtual characters controlled by the target user account in the battle and arrangement position information of the virtual characters;
real-time battle information of the second information category displaying an association relationship between the virtual objects controlled by the target user account in the battle; and
real-time battle information of the third information category displaying a virtual resource owned by the target user account in the battle.

18. The non-transitory computer-readable storage medium according to claim 15, wherein the method further comprises:
displaying options respectively corresponding to a plurality of information categories in response to the operation on the target identifier; and
performing an operation of displaying the real-time battle information of the target information category of the target user account in response to an operation on an option corresponding to the target information category among the plurality of information categories.

19. The non-transitory computer-readable storage medium according to claim 15, wherein the method further comprises:
determining a display position of the real-time battle information based on a display position of the target identifier; and
displaying the real-time battle information of the target information category of the target account at the display position of the real-time battle information.

20. The non-transitory computer-readable storage medium according to claim 15, wherein the displaying, within the user interface of the battle, identifiers of user accounts participating in the battle comprises:
determining candidate user accounts participating in the battle;
selecting, from the candidate user accounts, the user accounts satisfying a predefined condition; and
displaying the identifiers of the user accounts that satisfying the predefined condition.

21. The non-transitory computer-readable storage medium according to claim 15, wherein the method further comprises:
obtaining a slide trajectory of a slide operation in response to the slide operation on the target identifier;
determine, according to a sub-region through which the slide trajectory passes, an information category corresponding to the sub-region as an information category corresponding to the real-time battle information; and
displaying the real-time battle information of the target user account according to the information category corresponding to the real-time battle information.
